(19) United States
(12) Patent Application Publication
(10) Pub. No.: US 2025/0258384 A1
(43) Pub. Date: Aug. 14, 2025

(54) METHOD FOR DETERMINING OPTICAL PROPERTIES OF A CALIBRATION DEVICE

(71) Applicant: Robert Bosch GmbH, Stuttgart (DE)

(72) Inventors: Daniel Schraft, Pfinztal - Soellingen (DE); Moritz Kick, Ostfildern (DE)

(21) Appl. No.: 19/040,124

(22) Filed: Jan. 29, 2025

(30) Foreign Application Priority Data
Feb. 8, 2024 (DE) 10 2024 201 146.0

(51) Int. Cl. G02B 27/62; G02B 27/30; G03B 17/56

(52) U.S. Cl. CPC G02B 27/62; G02B 27/30; G03B 17/565

(57) ABSTRACT

A method for determining optical properties of a calibration device with respect to cameras to be calibrated. The calibration device includes a laser, directed toward the camera, a diffractive optical element, positioned between the camera and the laser, an autocollimator which receives a reflection of the autocollimator light and of a laser beam from the diffractive optical element via a beam splitter. The method includes determining, using the autocollimator, an autocollimator light incidence angle on the diffractive optical element; determining, using the autocollimator, a difference angle between the autocollimator light and a reflection of the laser beam from the diffractive optical element; calculating a laser incidence angle on the diffractive optical element from the difference angle and the autocollimator light incidence angle on the diffractive optical element, and calculating diffraction angles of the laser beam at the diffractive optical element using the laser incidence angle.

### CROSS REFERENCE

The present application claims the benefit under 35 U.S.C. § 119 of German Patent Application No. DE 10 2024 201 146.0 filed on Feb. 8, 2024, which is expressly incorporated herein by reference in its entirety.

### FIELD

The present invention relates to a method for determining optical properties of a calibration device with respect to cameras to be calibrated. In addition, the present invention relates to a calibration device for carrying out such a method.

### BACKGROUND INFORMATION

The cameras used in vehicles for driver assistance systems or automated driving systems have a plurality of functions, including recognizing objects in the scene by means of various object recognition algorithms. For many of these algorithms, the world-to-camera or camera-to-world transformation must be known, which means that the optical parameters of the camera must be known. These parameters include the focal length, the principal point, and the optical distortion parameters such as radial and non-radial distortion parameters. Intrinsic calibration is the process of determining the optical distortion of the camera. A space-and cost-saving method for camera calibration is based on the use of a diffractive optical element.

U.S. Pat. No. 3,912,395 A discloses a method for calibrating the distortion in optical systems. A collimated light beam is diffracted in different directions by guiding it through a diffraction grating. The diffracted light exiting the grating is then refocused by the calibrated optical system, creating a series of images in the focal plane of the optical system. The relationship between the actual positions of the images in the array and the calculated positions for a distortion-free system is a measure of the distortion present in the system.

German Patent Application No. DE 10 2022 104 717 A1 describes a method for determining and correcting a center axis shift caused by the installation of an optical layer above a camera arrangement. In this case, a pixel location shift, which is caused by a pane in front of a camera arrangement and results from a center axis shift brought about by the window, is determined on a calibration target. Accordingly, a transformation is generated, which corrects the pixel location shift caused by the pane in front of the camera arrangement, so that the pixel locations with the pane correspond to the pixel locations without the pane.

An object of the present invention is to provide a method for determining optical properties of a calibration device with respect to cameras to be calibrated, with which method an accuracy of the camera calibration is increased.

The object may be achieved by a method including certain features of the present invention. Preferred embodiments of the present invention are disclosed herein.

### SUMMARY

The present invention provided a method for determining optical properties of a calibration device with respect to cameras to be calibrated. According to an example embodiment of the present invention, the calibration device comprises a laser, which is directed toward the camera to be calibrated, and a diffractive optical element, which is positioned between the camera and the laser, wherein an autocollimator is provided, which receives a reflection of the autocollimator light and of a laser beam from the diffractive optical element via a beam splitter positioned in the beam path between the laser and the diffractive optical element.

Optical properties are values of the calibration device which affect the accuracy of a camera to be calibrated. A diffractive optical element is an element with which a light beam is formed. The autocollimator light refers to the light beam emitted by a light source of the autocollimator.

The method according to an example embodiment of the present invention comprises the steps of determining, by means of the autocollimator, an autocollimator light incidence angle on the diffractive optical element, and determining, by means of the autocollimator, a difference angle between the autocollimator light and a reflection of the laser beam from the diffractive optical element. The method additionally comprises the steps of calculating a laser incidence angle on the diffractive optical element from the difference angle and the autocollimator light incidence angle on the diffractive optical element, and calculating diffraction angles of the laser beam at the diffractive optical element by means of the laser incidence angle.

Accordingly, it is known which image should reach the camera to be calibrated. On the basis of the image ascertained by the camera and on the basis of the computationally determined image, deviations can be determined with high accuracy. This makes it possible to calibrate the camera according to these deviations. This increases the accuracy of the camera calibration.

In a preferred embodiment of the present invention, a pitch angle, yaw angle, and rotation angle of a camera receptacle formed on a camera mount are determined. The method comprises the steps of determining, by means of the autocollimator, an autocollimator light incidence angle on a mirror arranged in the camera receptacle of the camera mount, determining, by means of the autocollimator, an angular deviation between the autocollimator light and a reflection of the laser beam from the mirror, and calculating a laser incidence angle on the mirror from the angular deviation and the autocollimator light incidence angle. In addition, the method comprises the steps of calculating a pitch angle and yaw angle of the camera receptacle by means of the laser incidence angle on the mirror, determining an element rotation angle between the diffractive optical element and an element mount of the diffractive optical element, and tactilely determining a mount rotation angle between the element mount and the camera receptacle. In a last step of the method, a rotation angle between the diffractive optical element and the camera receptacle is determined from the element rotation angle and the mount rotation angle.

A pitch angle is an angle of movement of the camera about a transverse axis of the camera. The yaw angle describes an angle of movement about a vertical axis of the camera. Accordingly, a rotation angle indicates an angle of movement about a longitudinal axis of the camera. Instead of the camera, a mirror is arranged in the camera receptacle. The mirror is arranged in the camera receptacle in the same way as the camera. The mirror can thus be used to simulate the position of the camera in the receptacle. However, in contrast to the camera, the mirror makes it possible to determine the position in the camera receptacle by means of the autocollimator.

The tactile determination is carried out by a separate tactile measuring device. This measuring device approaches specific measuring points on the element mount and the camera receptacle. The corresponding values can subsequently be used to determine the mount rotation angle between the element mount and the camera receptacle. By additionally determining the pitch angle, yaw angle, and rotation angle of the camera receptacle, the position of the camera in space and in relation to the diffractive optical element can be determined accurately. This procedure allows the absolute orientation of the camera to be determined.

In a further preferred embodiment of the present invention, the element rotation angle is determined by ascertaining an angle between an actual reference line, or a reference line formed by reference points, of the diffractive optical element and an actual reference line, or a reference line formed by reference points, of the element mount. A reference line is an object which is shaped as a line and used to determine a rotation angle to a further reference line with high accuracy. An actual reference line is also formed as a line at or on the body. In contrast, a reference line formed by reference points does not actually exist but can be formed imaginarily by connecting these reference points. Such reference lines have the advantage that they can be formed with high accuracy and that an angle between these reference lines can be easily determined.

According to an example embodiment of the present invention, preferably, the autocollimator is oriented so that the autocollimator light impinges perpendicularly on the diffractive optical element. By orienting the autocollimator in this way, the calculation of the optical properties can be simplified.

In an advantageous development of the present invention, the laser incidence angle on the diffractive optical element is determined continuously. The laser incidence angle is thus measured not only after the calibration device has been set up but also at predetermined time intervals during the calibration of the cameras. A change in the laser incidence angle can therefore be easily corrected so that the accuracy of the camera calibration is increased. Continuously measuring the laser incidence angle also makes it possible to dispense with a rigid and expensive mechanical structure of the calibration device so that such a calibration can be carried out economically with high accuracy.

The object of the present invention may be achieved by a calibration device for calibrating cameras. The calibration device has optical properties with respect to the camera, which are ascertained using the method according to the present invention. According to an example embodiment of the present invention, the calibration device comprises a camera mount for mounting a camera to be calibrated, a laser, which is directed toward the camera to be calibrated, and a diffractive optical element, which is positioned between the camera and the laser. In addition, the calibration device comprises an element mount for mounting the diffractive optical element, a beam splitter, which is arranged between the diffractive optical element and the laser, and an autocollimator, which receives a reflection from the direction of the diffractive optical element via the beam splitter.

Such a calibration device essentially has the advantages and properties described above.

According to an example embodiment of the present invention, advantageously, the diffractive optical element has at least one reference line and/or reference points. Such reference lines or reference points increase the accuracy of ascertaining the element rotation angle. Such reference points can already be created during the production of the diffractive optical element. Since the creation of the diffractive optical element requires high accuracy, the reference points can be formed during the production with equally high accuracy.

In a further advantageous embodiment of the present invention, at least one reference line and/or reference points are formed on the element mount. Such a reference line or reference points increase the accuracy of ascertaining the element rotation angle. This also simplifies ascertaining the element rotation angle.

According to an expedient embodiment of the present invention, the reference line and/or the reference points are formed in such a way that they can be measured tactilely. Advantageously, the reference points are designed as drill holes, which makes both tactile and optical determination possible. Alternatively, it is also possible to form the reference points as 3D objects. By designing the reference line and the reference points in this way, tactilely measuring these elements is simplified.

According to a further expedient embodiment of the present invention, a camera receptacle formed on the camera mount forms a reference surface. The reference surface is oriented in such a way that it can be used to ascertain a rotation of the camera receptacle. Advantageously, the reference surface extends in such a way that a normal vector of the reference surface is orthogonal to the rotation axis of the camera mount. A reference surface has the advantage that it can be easily detected tactilely. It is particularly advantageous if the reference surface forms part of the camera receptacle. The camera thus abuts the reference surface directly and has the same rotation as the reference surface. On the one hand, the reference surface thus forms the camera receptacle and, on the other hand, this surface also serves as a reference surface so that no separate surface has to be formed.

The present invention additionally provides a method for calibrating a camera in a calibration device. The method comprises the steps of inserting the camera into the camera mount, capturing an image generated in the camera by the laser beams diffracted at the diffractive optical element, and determining pixel coordinates of image points generated by the diffracted laser beams. In a final step, the optical properties of the camera are determined from the ascertained pixel coordinates and the diffraction angles of the diffracted laser beams, which diffraction angles ascertained computationally on the basis of the optical properties of the calibration device.

Diffracted laser beams are the beams of the laser beam that have been split into individual laser beams by the diffractive optical element and that have been diffracted by the diffractive optical element. In other words, the previously uniform laser beam is divided into a multitude of individual laser beams. Pixel coordinates are the spatial determination of the image points generated on the image sensor of the camera by the diffracted laser beams.

Exemplary embodiments of the present invention are illustrated in the figures and explained in more detail in the following description.

### BRIEF DESCRIPTION OF THE DRAWINGS

FIG. 1 is a schematic representation of a calibration device for calibrating cameras according to an exemplary embodiment of the present invention.

FIG. 2 is a representation of an element mount and of the diffractive optical element, according to an example embodiment of the present invention.

FIG. 3 is a representation of the camera mount with a camera receptacle and a mirror, according to an example embodiment of the present invention.

FIG. 4 shows an exemplary embodiment of a method for determining optical properties of the calibration device, according to an example embodiment of the present invention.

FIG. 5 is a representation of a camera with a pitch angle, yaw angle, and rotation angle, according to an example embodiment of the present invention.

FIG. 6 shows an exemplary embodiment of a method for calibrating the camera in the calibration device, according to an example embodiment of the present invention.

### DETAILED DESCRIPTION OF EXAMPLE EMBODIMENTS

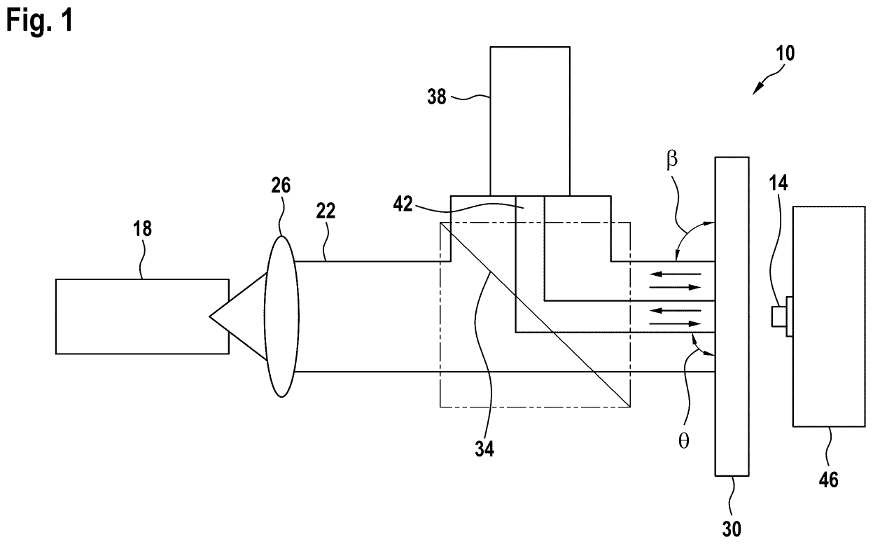

FIG. 1 is a schematic representation of a calibration device 10 for calibrating cameras 14 according to an exemplary embodiment of the present invention. The calibration device 10 comprises a laser 18, which is oriented toward the camera 14 to be calibrated. A laser beam 22 emitted by the laser 18 can be optically adjusted by a lens 26 arranged downstream of the laser 18. A diffractive optical element 30 is arranged between the camera 14 and the laser 18. The calibration device 10 additionally has a beam splitter 34, which is positioned in the beam path between the laser 18 and the diffractive optical element 30. A reflection of the laser beam 22 at the diffractive optical element 30 can be transmitted to an autocollimator 38 via this beam splitter 34.

In the exemplary embodiment shown, the autocollimator 38 is arranged orthogonally to the beam path between the laser 18 and the diffractive optical element 30. An autocollimator light 42 is redirected via the beam splitter 34 so that it impinges on the diffractive optical element 30. A camera mount 46, by which the camera 14 is mounted, is arranged downstream of the diffractive optical element 30.

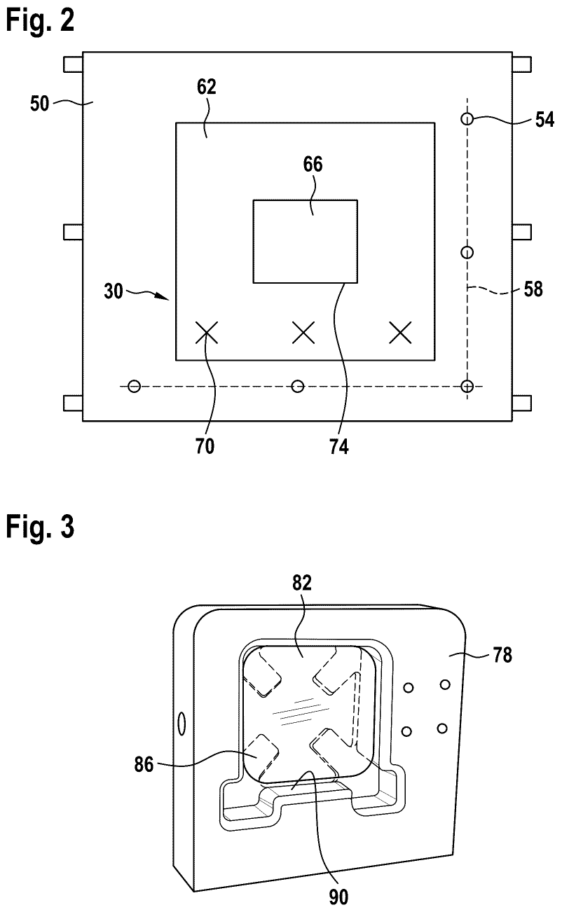

FIG. 2 is a representation of an element mount 50 and of the diffractive optical element 30. The diffractive optical element 30 is mounted by the element mount 50. The element mount 50 forms a plurality of reference points 54 arranged perpendicularly to one another and a plurality of reference points arranged horizontally to one another. In this exemplary embodiment, the reference points 54 are designed as drill holes. The reference points 54 form imaginary reference lines 58. A rotation of the diffractive optical element 30 in relation to the element mount 50 can be determined by the reference lines 58. The diffractive optical element 30 is formed from a substrate 62 and an active surface 66 positioned on the substrate 62. Additionally, three crosses 70 arranged horizontally to one another are formed on the substrate 62 and serve as reference points of the diffractive optical element 30. An outer edge 74 of the active surface 66 of the diffractive optical element 30 forms a reference line 74.

FIG. 3 is a representation of the camera mount 46 with a camera receptacle 78 and a mirror 82. In the exemplary embodiment shown, the camera receptacle 78 is designed as a rectangular cutout in the camera mount 46 so that a camera 14 can be accommodated in the camera receptacle 78. The camera receptacle 78 forms four protrusions 86, which protrude into the camera receptacle 78. The protrusions 86 form a defined contact surface for the camera 14. The camera receptacle 78 forms reference surfaces 90, by which a mount rotation angle between the element mount 50 and the camera receptacle 78 can be determined tactilely. In the exemplary embodiment shown here, instead of a camera 14, the mirror 82 is arranged in the camera receptacle 78. This mirror 82 makes it possible to calibrate the camera mount 46 and the camera receptacle 78.

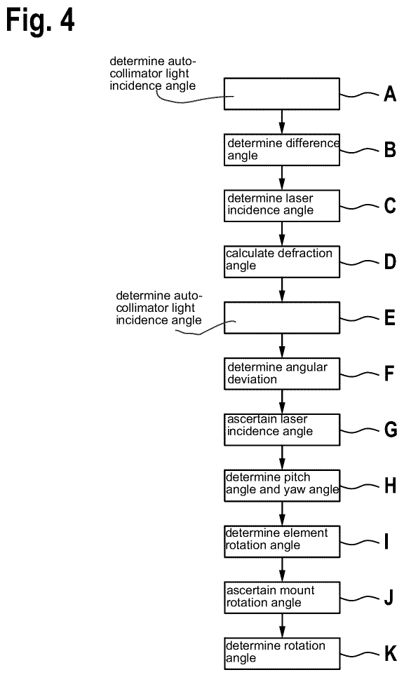

FIG. 4 shows an exemplary embodiment of a method for determining optical properties of the calibration device 10. In a first step A of the method, an autocollimator light incidence angle 0 on the diffractive optical element 30 is determined by means of the autocollimator 38. For this purpose, an angle between a reflection of the autocollimator light 42 from the diffractive optical element 30 and the autocollimator light 42 emitted by the autocollimator 38 is determined. In a next step B, a difference angle between the emitted autocollimator light 42 and a reflection, received by the autocollimator 38, of the laser beam 22 from the diffractive optical element 30 is determined by means of the autocollimator 38.

In a subsequent step C, a laser incidence angle β on the diffractive optical element 30 is determined. For this purpose, the angle between the difference angle and the autocollimator light incidence angle θ is ascertained. This angle corresponds to the laser incidence angle β on the diffractive optical element 30. In a next step D, the diffraction angles of the laser beam 22 at the diffractive optical element 30 are calculated from the laser incidence angle β and the properties of the diffractive optical element 30.

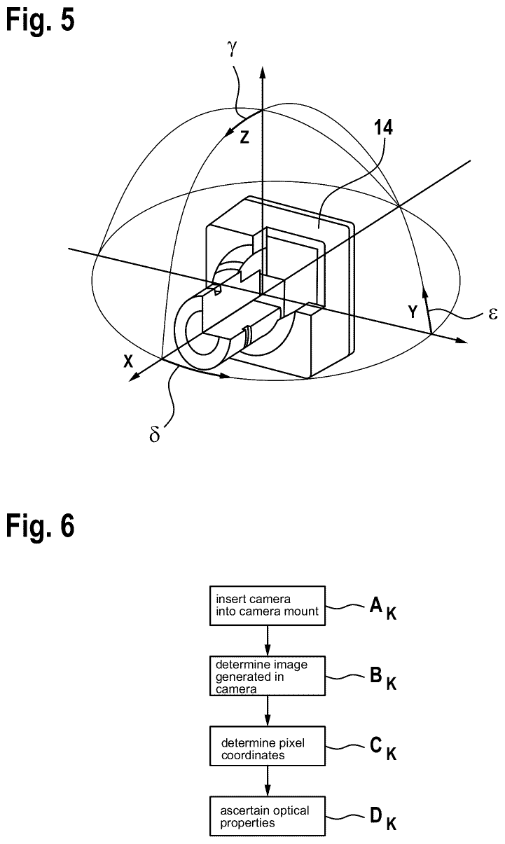

In order to determine the orientation of the camera 14 in the calibration device 10, knowledge of a pitch angle γ, yaw angle γ, and rotation angle & is important. The pitch angle γ describes, as shown in FIG. 5, an angle about a transverse axis y of the camera 14. The transverse axis y is orthogonal to a longitudinal axis x and to a vertical axis z of the camera 14. In contrast, the yaw angle δ describes, as shown in FIG. 5, an angle about a vertical axis z of the camera 14, whereas the rotation angle ε describes an angle about a longitudinal axis x of the camera 14.

In order to determine the pitch angle γ and yaw angle δ of the camera receptacle 78 of the camera mount 46, the autocollimator light incidence angle on the mirror 82 arranged in the camera receptacle 78 of the camera mount 46 is determined in a next step E. For this purpose, the angle between the autocollimator light 42 emitted by the autocollimator 38 and the autocollimator light 42 reflected by the mirror 82 is determined by means of the autocollimator 38. Subsequently, in a next step F, an angular deviation between the autocollimator light 42 and a reflection of the laser beam 22 from the mirror 82 is determined by means of the autocollimator 38. In a further step G, a laser incidence angle on the mirror 82 is ascertained from the angular deviation and the autocollimator light incidence angle on the mirror 82. The pitch angle γ and yaw angle 8 of the camera receptacle 78 can subsequently be determined on the basis of the laser incidence angle (step H).

For determining the rotation angle ε, an element rotation angle between the diffractive optical element 30 and the element mount 50 of the diffractive optical element 30 is determined in a next step I. Here, an angle between an imaginary reference line formed by the reference points 70 of the diffractive optical element 30 and the imaginary reference line 58 through the reference points 54 of the element mount 50 is determined. It is also possible to determine an angle between a reference line formed by the outer edge 74 of the active surface 66 of the diffractive optical element 30 and the reference line 58 of the element mount 50. The determined angle corresponds to the element rotation angle between the diffractive optical element 30 and the element mount 50.

In a next step J, a mount rotation angle between the element mount and the camera receptacle 78 is ascertained by a tactile determination. For this purpose, the reference points 54 of the element mount 50 and the reference surface 90 of the camera receptacle 78 are approached tactilely. In a next step K, a rotation angle ε between the diffractive optical element 30 and the camera receptacle 78 is determined from the element rotation angle and the mount rotation angle.

FIG. 6 shows an exemplary embodiment of a method for calibrating the camera 14 in the calibration device 10. In a first step AK of the method, the camera 14 is inserted into the camera mount 46. In a next step BK, an image generated in the camera 14 is determined by means of the laser beam 22 emitted by the laser 18. Before impinging in the camera 14, the laser beam 22 impinges on the diffractive optical element 30 at the calculated laser incidence angle B. According to this incidence angle B, the laser beam 22 is diffracted at the diffractive optical element 30 before the diffracted laser beams 22 impinge on an image sensor of the camera 14.

In a further method step C_{K}, pixel coordinates of image points generated by the laser beams 22 are determined. In a final step DK, the optical properties of the camera 14 are ascertained. This is done on the basis of the ascertained pixel coordinates and on the basis of the previously ascertained optical properties of the calibration device 10. For this purpose, the optical properties of the calibration device 10 and the known laser incidence angle β are used to computationally ascertain which pixel coordinates should be present. The optical properties of the camera 14 are thus determined on the basis of the computationally ascertained coordinates and on the basis of the actual pixel coordinates.

What is claimed is:

1. A method for determining optical properties of a calibration device with respect to cameras to be calibrated, the calibration device including a laser, which is directed toward a camera to be calibrated, and a diffractive optical element, which is positioned between the camera and the laser, wherein an autocollimator is provided, which receives a reflection of autocollimator light and of a laser beam from the diffractive optical element via a beam splitter positioned in a beam path between the laser and the diffractive optical element, the method comprising the following steps:
determining, via the autocollimator, an autocollimator light incidence angle on the diffractive optical element;
determining, via the autocollimator, a difference angle between the autocollimator light and a reflection of the laser beam from the diffractive optical element;
calculating a laser incidence angle on the diffractive optical element from the difference angle and the autocollimator light incidence angle on the diffractive optical element; and
calculating diffraction angles of the laser beam at the diffractive optical element using the laser incidence angle.

2. The method according to claim 1, wherein a pitch angle, a yaw angle, and rotation angle of a camera receptacle formed on a camera mount are determined, and wherein the method further comprises the following steps:
determining, via the autocollimator, an autocollimator light incidence angle on a mirror arranged in the camera receptacle of the camera mount;
determining, via the autocollimator, an angular deviation between the autocollimator light and a reflection of the laser beam from the mirror;
calculating a laser incidence angle on the mirror from the angular deviation and the autocollimator light incidence angle;
calculating a pitch angle and yaw angle of the camera receptacle using the laser incidence angle on the mirror;
determining an element rotation angle between the diffractive optical element and an element mount of the diffractive optical element;
tactilely determining a mount rotation angle between the element mount and the camera receptacle; and
determining a rotation angle between the diffractive optical element and the camera receptacle from the element rotation angle and the mount rotation angle.

3. The method according to claim 2, wherein the element rotation angle is determined by ascertaining an angle between: (i) an actual reference line, or a reference line formed by reference points, of the diffractive optical element, and (ii) an actual reference line, or a reference line formed by reference points, of the element mount.

4. The method according to claim 1, wherein the autocollimator is oriented so that the autocollimator light impinges perpendicularly on the diffractive optical element.

5. The method according to claim 1, wherein the laser incidence angle on the diffractive optical element is determined continuously.

6. A calibration device for calibrating a camera, which has optical properties with respect to the camera, the calibaration device comprising:
a camera mount configures to mount a camera to be calibrated;
a laser directed toward the camera to be calibrated;
a diffractive optical element positioned between the camera and the laser;
an element mount configured to mount the diffractive optical element;
a beam splitter, which is arranged between the diffractive optical element and the laser; and
an autocollimator, which receives a reflection from a direction of the diffractive optical element via the beam splitter.

7. The calibration device according to claim 6, wherein the optical properties of the calibration device are determined by:
determining, via the autocollimator, an autocollimator light incidence angle on the diffractive optical element;
determining, via the autocollimator, a difference angle between the autocollimator light and a reflection of the laser beam from the diffractive optical element;
calculating a laser incidence angle on the diffractive optical element from the difference angle and the autocollimator light incidence angle on the diffractive optical element; and
calculating diffraction angles of the laser beam at the diffractive optical element using the laser incidence angle.

8. The calibration device according to claim 6, wherein the diffractive optical element has at least one reference line and/or reference points.

9. The calibration device according to claim 6, wherein at least one reference line and/or reference points are formed on the element mount.

10. The calibration device according to claim 9, wherein the reference line and/or the reference points are formed in such a way that they can be measured tactilely.

11. The calibration device according to claim 6, wherein a camera receptacle formed on the camera mount forms a reference surface.

12. A method for calibrating a camera in a calibration device, the calibration device including:
a camera mount configures to mount the camera to be calibrated,
a laser directed toward the camera to be calibrated,
a diffractive optical element positioned between the camera and the laser,
an element mount configured to mount the diffractive optical element,
a beam splitter, which is arranged between the diffractive optical element and the laser, and
an autocollimator, which receives a reflection from a direction of the diffractive optical element via the beam splitter;
the method comprising the following steps:
inserting the camera into the camera mount;
capturing an image generated in the camera by laser beams diffracted at the diffractive optical element;
determining pixel coordinates of image points generated by the diffracted laser beams;
determining optical properties of the camera from the ascertained pixel coordinates and the diffraction angles of the diffracted laser beams, which diffraction angles are ascertained computationally based on optical properties of the calibration device.

13. The method according to claim 12, wherein the optical properties of the calibration device are determined by:
determining, via the autocollimator, an autocollimator light incidence angle on the diffractive optical element;
determining, via the autocollimator, a difference angle between the autocollimator light and a reflection of the laser beam from the diffractive optical element;
calculating a laser incidence angle on the diffractive optical element from the difference angle and the autocollimator light incidence angle on the diffractive optical element; and
calculating diffraction angles of the laser beam at the diffractive optical element using the laser incidence angle.
